(19) United States
(12) Patent Application Publication
(10) Pub. No.: US 2014/0278674 A1
(43) Pub. Date: Sep. 18, 2014

(54) COMPUTER-IMPLEMENTED SINGLE CALENDAR SYSTEM

(71) Applicants: Kourosh Gohar, Los Angeles, CA (US); Tony Rhoton, American Fork, UT (US); Todd M. Zebert, Encino, CA (US); Jackie Chang, Los Angeles, CA (US)

(72) Inventors: Kourosh Gohar, Los Angeles, CA (US); Tony Rhoton, American Fork, UT (US); Todd M. Zebert, Encino, CA (US); Jackie Chang, Los Angeles, CA (US)

(73) Assignee: Kuyam Companies, Inc., Los Angeles, CA (US)

(21) Appl. No.: 13/837,413

(22) Filed: Mar. 15, 2013

(51) Int. Cl. G06Q 10/10

(52) U.S. Cl. CPC G06Q 10/1095
USPC 705/7.19; 705/7.18

(57) ABSTRACT

A computer implemented method of scheduling all calendar events for a user comprising a single platform for setting multiple appointments with different establishments, a database of establishments available for the user to search, the database comprising a profile of each establishment,

an integrated clock and calendar for scheduling an event at an establishment at a specific date and time and the scheduled event is automatically superimposed onto other calendars utilized by the user.

### FIELD OF THE INVENTION

The present invention comprises a platform that acts as a marketplace which empowers its users, the buyers of listed services and its establishments, the sellers of listed services the capabilities to search, discover, schedule, share and store a user based schedule.

### Background of the Invention

Technology has provided public and private establishments with many means for consumers to schedule appointments. Consumers can make an appointment with an establishment over the phone or via email. Some establishments even offer consumers an option to schedule appointments online by visiting the establishment's website. While technology has made this process easier, consumers who wish to make appointments with multiple establishments have to make several phone calls, and/or log onto several different websites for each establishment. Furthermore, most establishments still lack the means to allow consumers to make appointments online. These limitations waste valuable time and are mistake prone. There is a need to provide consumers with a single integrated platform, a “one stop shop”, which allows consumers to make, modify or cancel online appointments, all on one platform.

### SUMMARY OF THE INVENTION

The present invention provides a single platform capable of setting up various appointments with different establishments. By providing its users with a single platform capable of making appointments with different establishments, this invention saves its users time spent on logging onto multiple websites or making several phone calls in order to make appointments with different establishments. The present invention also creates an online platform to help its users to organize their schedules. The present invention also allows its users to arrange group meetings, and create or schedule live events using a single integrated platform.

The platform offers its users a convenient method to view the establishments' availability calendar and an option for the user to superimpose the user's own third party calendars (such as Google Calendar, iCal or Facebook events) on top of the establishments' availabilities. The user can also superimpose the establishment's availabilities over the user's own third party calendars. The platform also allows users to book appointments with the establishments directly through the platform. In addition, the platform allows users to create, schedule and initiate events with other users (such as play dates, rideshares, etc.)

It is an object of the present invention to provide a platform capable to search, discover, schedule, share and/or store a user based schedule. It is a further object of the present invention to connect its users to different establishments and to set up appointments with each establishment, on one calendar. It is yet another object of the present invention to provide an easy to use platform which helps its users organize their schedules, arrange group meetings, and create or schedule live events. It is still another object of the present invention to provide a method for its users to use the platform to connect to establishments, to schedule appointments with each establishment, create live events or arrange group meetings.

The present invention provides a company profile page for each of the establishments listed on its platform, with a built in clock and an integrated calendar. The company profile page includes a calendar with any and all available time slots, associated with specific services and in some cases, a specific employee for the establishment. In addition to the company's profile page calendar, there is a real world calendar which is divided into months, weeks, days, and may also have an agenda or list format. Furthermore, each day of the calendar is divided into several smaller increments.

A user of the site is able to create, edit or delete multiple calendars on the platform to organize the user's calendars such as those of the user's family, colleagues or other third party people. An example would be, Jane's calendar, John's calendar, the kid's calendars, etc.

It is the object of the present invention to superimpose its users' and establishments' calendars, its users' third party calendars (such as Google Calendar, iCal, and/or Facebook events and other third party calendars).

The platform contains a list of establishments. The platform allows participating establishments to provide their contact information and provide the platform's users with special announcements, special package offers and discounts.

The platform contains functions which allow establishments to promote themselves to the platform's users The platform is capable of setting aside a specific day to focus on promoting a specific type of establishment. For example, the platform may allot X days to promote for-profit establishments; Y days to promote non-profit establishments; or X days to promote schools or bloggers. A particular allocation of time for promoting establishments may be instituted and modified at the sole discretion of the platform's service provider.

The platform contains a function which allows users to search the list of establishments for a desired establishment to make an appointment, and search the list of available time slots of establishments to make an appointment. The user can choose to make an appointment with any establishment on the list of establishments by allotting an increment of time in the calendar for the designated establishment. If a user cannot find the type of establishment he or she is searching for, the platform contains a feature which allows the user to request an establishment be added to the platform.

The platform also contains a feature which allows its users to tag an establishment as the user's favorite establishment, resulting in listing the tagged favorite establishment in the user's “select a favorite” category, with a dropdown button for ease of use.

In addition, the platform contains a feature which allows establishments to offer a special package to users, which they can purchase and it can be listed in the “select a package” dropdown button for ease of use.

The platform also contains a feature which allows users to rate establishments. The rating of an establishment is dependent on the overall user rating of the establishment and it may be expressed in several ways, including but not limited to, a bar, a graph or stars.

The platform contains a list of users and can allow users to search the list. The platform also contains features which allow users to block being on the list. The platform also contains a contact list to allow each user to store user information and contact information of establishments. The platform also contains a feature that allows establishments and users to invite other persons to become a user of the platform.

The platform contains features which allow an establishment to charge an appointment fee. The platform also allows the establishment to implement, modify, or reverse any fee charged. The numerical amount of the fee charged may be modified or waived by the service provider. The cancellation of the fee cannot be changed or modified by the users of the platform. For example, a fee may or may not be charged based on the types of services offered to a user. The specific types of services which require a fee charge may be implemented, modified, or set aside at any time by the service provider. If a member or establishment has selected a service which has been predetermined as one which requires a fee charge, then the platform would charge a fee for that particular amount. Regular clients may get a lower fee charged.

The platform can contain a geo-location feature, which allows local establishments to make promotions to its “local members”. The platform may contain several parameters to determine the “local members” of each establishment. For example, “local member” may mean all users within a certain distance of the establishment, such as users living within 10 miles of the establishment. Parameters may be implemented, modified or removed by the platform's service provider.

The platform contains features which allow users of the platform to communicate with each other. Such features include means of direct communication between users, or communication of users through a community forum. The platform also contains features which allow users to post questions for other users to answer.

The platform contains functions that allow establishments to upload onto the platform, photos or a video of the establishment. In addition, the platform contains functions that allow establishments to purchase stock images through the platform.

The platform contains functions that allow users to write reviews of an establishment or make recommendations based on a user's experience with the establishment. Each establishment has a review section which is directly proportional to the amount of feedback given to an establishment.

The platform has features which allow the users to book appointments through searching for available times. The platform offers users several means to reschedule or cancel their appointments or events. The platform allows users to make instant modifications with or without a penalty (depending on the establishment's cancellation policies). However, the platform also has built in features to evaluate the time difference between the time the cancellation order is initiated and the actual appointment time. Depending on the timing of the cancellation order, the platform may issue a no-show notice and depending the establishment's cancellation policies, collect cancellation fees.

The platform has features which allow users to create, modify or cancel their own events and appointments. Users may designate the exclusivity of their events and may, or may not, invite other users to attend. The platform also contains features which allow a subgroup of users to set aside a specific time for a meeting, or event. For example, the platform may allow two individuals to set aside a mutually convenient time for a particular meeting (such as play dates or carpool.)

This platform can be integrated with mobile devices such as smartphones, and other electronic devices such as tablets, and computers. This platform allows users to synchronize their schedule and calendar with their particular mobile device such as smartphones, tablets or computers.

This platform contains means for users to enter their credit card, use third party payment platforms (such as PayPal or others) as well as other personal information. Furthermore, this platform contains means to protect such information from unauthorized third parties.

### BRIEF DESCRIPTION OF THE DRAWINGS

FIG. 1 is a diagram illustrating the step by step operation of the calendar system;

FIG. 2 shows an availability calendar on a company profile.

### DETAILED DESCRIPTION

Referring to the drawings, FIG. 1 shows the steps taken to utilize the calendar system of the invention. Step 100 the user has either logged in the platform or no logins may be required in order for the user to have access to the platform. Step 101 the user can search by either category, by name or by location to find what they are looking for. Step 103 the user is in the marketplace where they can search, discover and learn more about the various listed companies on the platform. The user can also have access to their dashboard to check schedules, appointments and calendars.

Step 200 the user can select the “schedule” tab to search by name; by category; or by location. Step 104 the user can learn more about each company in the listings search results by selecting a company to see a mini profile of the company. Step 105 the user elects to learn more about the establishment's availabilities. Step 106 the user is directed to view the company's profile page with its availability calendar shown.

Step 112 the user can simply select an available time slot from the availability calendar to schedule an appointment and step 113 the user selects the desired services that they want and they also select the specific user's calendar the services are for, such as which family member the services are for. Step 114 the user views a detailed summary of the requested appointment.

Step 115 the user can checkout, book and pay for the appointment using a third party credit card processing, or simply checkout, book and pay in person to the establishment directly at the time of the appointment. The payment option is set up in the settings, showing what payment methods are available for this establishment.

Step 116, in the company settings, the establishment can set whether the appointment being booked by the user is an instant booking or requires a confirmation step. If it is an instant booking, the user will receive an instant confirmation of the appointment and the appointment will be added to the user's calendar on the platform. The availability calendar will be updated to reflect such appointment. Step 117 in the company settings, the establishment can set if the appointment being booked by the user is an instant booking or requires a confirmation step. If it requires a confirmation step, once the appointment has been confirmed, the user will receive a confirmation of the appointment and the appointment will be added to the user's calendar on the platform. The availability calendar will be updated to reflect such appointment. Step 118 in case the establishment has not confirmed the appointment within a set time period of time, the request will be cancelled.

Step 119 the appointment request is now cancelled. Step 120 the company (establishment) confirms the appointment within a set time period and Step 121 the appointment request is now confirmed and booked.

Step 107 the user has the option to select and see their own third party calendars (such as Google calendar, iCal, Facebook events, amongst many other available selections. Step 108 their third party calendar information superimposes on top of the company's availability calendar. Now the user can see both the company's available times and its own third party calendar.

Step 109 the user selects a time slot within its third party calendar, which is now superimposed on top of the availability calendar. Step 110 the user's third party calendar details show up and Step 111 the user can select to remove any of the platform calendars or any of its third party calendars in order to see the establishment availability calendar.

Step 300 the user selects the calendar tab. Step 301 the user sees all its platform calendars and third party calendars in one place. The user can select to see or not to see any of its calendars by switching them on and off. Step 302 the user can edit their calendars by selecting the edit option. Step 303 the user can sync it's third party calendars with the platform by turning them on or off. Step 304, in the user settings section, the user can add, edit or delete the calendar settings.

Step 305 the user can modify the calendar specific information, such as add; rename; switch colors or delete a calendar. Step 307 the user can select which third party calendar they want to sync with.

Step 400 the user selects the appointment tab for updates. Step 401 the user sees all their requested appointments and their respective status, such as, pending, confirmed, modified, cancelled. Pending appointment status simply stays in “pending” until an action takes place. “Confirmed” means that the appointment has been confirmed by the establishment.

Step 407 the user elects to see their modified appointments. Step 408 the user can review and modify their appointments by viewing the availability calendar and simply changing the appointment day, time, or person booking the appointment and the calendar for which user the appointment is for. Step 409 if the user is trying to modify their appointment too close to the appointment time, a warming message notifies the user of any cancellation fees. Step 410 after the user completes their request for a modification the appointment will be automatically confirmed or a request will be sent to the establishment to confirm the latest update. Step 411 the establishment needs to respond or confirm the appointment modification request within a period of time.

Step 412 if the establishment hasn't responded within a period of time the appointment will be cancelled. Step 413 if the establishment confirms the modification request the appointment is confirmed and the user will be notified and the change to the appointment will reflect on the user's calendar and the company availability calendar.

Step 402 if the user selects to cancel an appointment, Step 403 a warning will set forth about any cancellation fees. Step 404 if the user continues with the cancellation, the appointment is now cancelled.

Step 405 the user can select to see notes for appointments. Step 406 the user can review past notes and messages from prior communications with the establishment.

Referring to FIG. 2, there is shown an Availability Calendar Web Version 700 and an Availability Calendar Mobile Version 800. Each company (establishment) has an availability calendar. When a user syncs their third party calendar 701 to the platform, the selected third party calendars for the user will show in the availability calendar 700.

The user can see the details of the third party calendar information by selecting and clicking inside the time slot. Available time slots are shown inside the availability calendar. The user can select/click inside the time slot to begin the process of scheduling an appointment with the company directly from its company profile page.

Unavailable time slots 703 from the company will be shown inside the availability calendar. The user's appointments booked on the platform will also appear in the availability calendar 700. The user can simply select or deselect the showing of a specific calendar if they wish to see it, to view or un-view the calendars the user can select/click on the calendar name specific section directly below the availability calendar 701, 704, 705.

When the user adds, edits, or deletes a calendar name on the platform, the changes will reflect on this availability calendar 700. The user can scroll up and down 706 to see more times of the day on the calendar.

The days being shown on the availability calendar 700 will be listed 707 above the availability calendar 700.

On the mobile version 800, there is shown the availability of a specific company, and the user can click to scroll to the day of the week 801. The user can click to view their third party calendar 802. Third party calendar activities show 803 if they exist during the company's available times. Available times can be scheduled 804. The calendar scrolls up and down 805 to see more times. The user can also see the availability of all of their favorite companies by clicking a favorites button.

When a user is traveling, or is in a location where he or she needs assistance, the user can go to the mobile platform or the web platform and enter the following information: the type of service required or a company name if the user knows of a company in that area. The user then enters their location or it is entered via a geo or GPS. The user then enters the date on which they want service and the time they want service. The user then enters or clicks on “Find It”. The user will receive a display of local companies and their availabilities within the entered parameters.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What we claim is:

1. A computer implemented method of scheduling all calendar events for a user comprising:
a single platform for setting multiple appointments with different establishments;
a database of establishments available for the user to search;
the database comprising a profile about each establishment;
an integrated clock and calendar for scheduling an event at an establishment at a specific date and time;
wherein the scheduled event is automatically superimposed onto other calendars utilized by the user.

2. The computer implemented method of scheduling all calendar events for a user of claim 1 in which the user's other calendars are one or more of Google Calendar, ICal, Facebook events and Microsoft Outlook or others.

3. The computer implemented method of scheduling all calendar events for a user of claim 2 in which the user can select which other calendars they want superimposed.

4. The computer implemented method of scheduling all calendar events for a user of claim 1 in which the establishment adds to the database one or more of special announcements, special packages, and special discounts.

5. The computer implemented method of scheduling all calendar events for a user of claim 1 in which the user can rate an establishment.

6. The computer implemented method of scheduling all calendar events for a user of claim 1 in which a fee is charged for user services.

7. The computer implemented method of scheduling all calendar events for a user of claim 1 in which a user can communicate with other users with reference to their experience at an establishment.

8. The computer implemented method of scheduling all calendar events for a user of claim 1 in which a user can modify one or more of the date and time of a scheduled event.

9. A computer implemented method of scheduling all calendar events for a user comprising:
a single platform for setting multiple appointments with different establishments;
a database of establishments available for the user to search;
the database comprising a profile about each establishment;
an integrated clock and calendar for scheduling an event at an establishment at a specific date and time;
wherein other scheduled events located on other calendars utilized by the user are automatically superimposed onto the platform.

10. The computer implemented method of scheduling all calendar events for a user of claim 9 in which an establishment must confirm an event scheduled by the user.

11. The computer implemented method of scheduling all calendar events for a user of claim 10 in which the establishment must confirm an event scheduled by the user within a set time period or the event is cancelled.

12. A computer implemented method of scheduling all calendar events for a user comprising:
a single platform for setting multiple appointments with different establishments;
a method for a user to obtain assistance when needed comprising entering into the platform the type of service required or a company name;
entering the user's location;
entering the date and time for which the service is requested;
then sending the assistance request to the platform.

13. The computer implemented method of scheduling all calendar events for a user of claim 1 in which the platform comprises a database of establishments searchable by users.

14. The computer implemented method of scheduling all calendar events for a user of claim 13 in which each establishment in the database provides a profile of information and an availability calendar.

15. The computer implemented method of scheduling all calendar events for a user of claim 13 in which the establishment adds to the database one or more of special announcements, special packages, and special discounts.
